(19) United States
(12) Patent Application Publication
(10) Pub. No.: US 2015/0281239 A1
(43) Pub. Date: Oct. 1, 2015

(54) PROVISION OF ACCESS PRIVILEGES TO A USER

(71) Applicant: Verizon Patent and Licensing Inc., Basking Ridge, NJ (US)

(72) Inventor: Timothy BROPHY, Forest Hill, MD (US)

(73) Assignee: Verizon Patent and Licensing Inc., Basking Ridge, NJ (US)

(21) Appl. No.: 14/226,060

(22) Filed: Mar. 26, 2014

(51) Int. Cl. H04L 29/06

(52) U.S. Cl. CPC H04L 63/10; H04L 63/08

(57) ABSTRACT

A device may receive, from a user device, an access request associated with a target device. The access request may include a particular level of access. The device may validate the access request based on information identifying a source of the access request. The device may request justification information based on validating the access request. The device may receive the justification information. The device may approve the access request based on the justification information. The device may configure a connection to the target device based on approving the access request. The device may provide, to the user device and without revealing credential information associated with the particular level of access to the source of the access request, information associated with the connection to the target device based on configuring the connection to the target device.

### BACKGROUND

A user associated with a user device may request access, such as administrator-level access or the like, to a target device. The target device may utilize an administrator-level credential, such as an administrator password, an administrator identifier, an administrator public key certificate, or the like, for access control.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for providing, to a user, access to a target device; and

FIGS. 5A-5E are diagrams of an example implementation relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

An administrator for a target device may utilize an administrator-level credential, such as a password, a user identifier, or the like, for gaining administrator-level access to the target device. A user of a user device, such as a troubleshooting engineer, an escalation engineer, or the like, may utilize access (e.g., administrator-level access) to the target device to perform maintenance, to adjust a configuration, to perform troubleshooting, or the like. However, the administrator may not desire to expose the administrator-level credential to the user of the user device. Implementations described herein may facilitate establishing a connection granting administrator-level access for a target device, to a user of a user device, without exposing an administrator-level credential to the user and/or the user device.

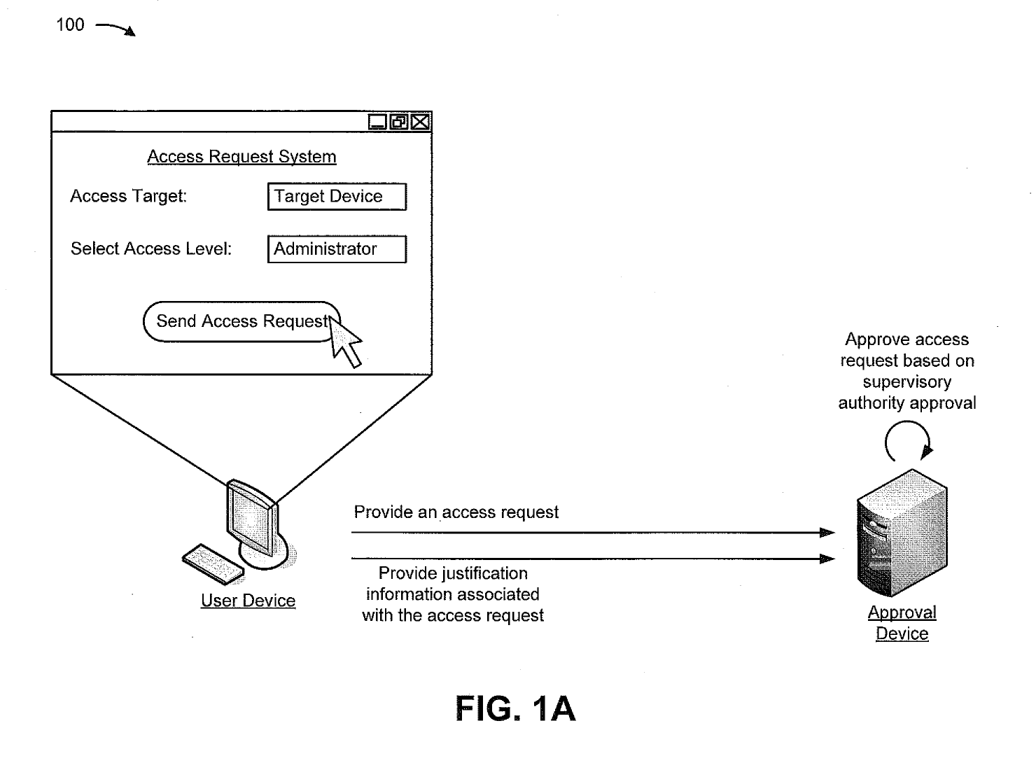

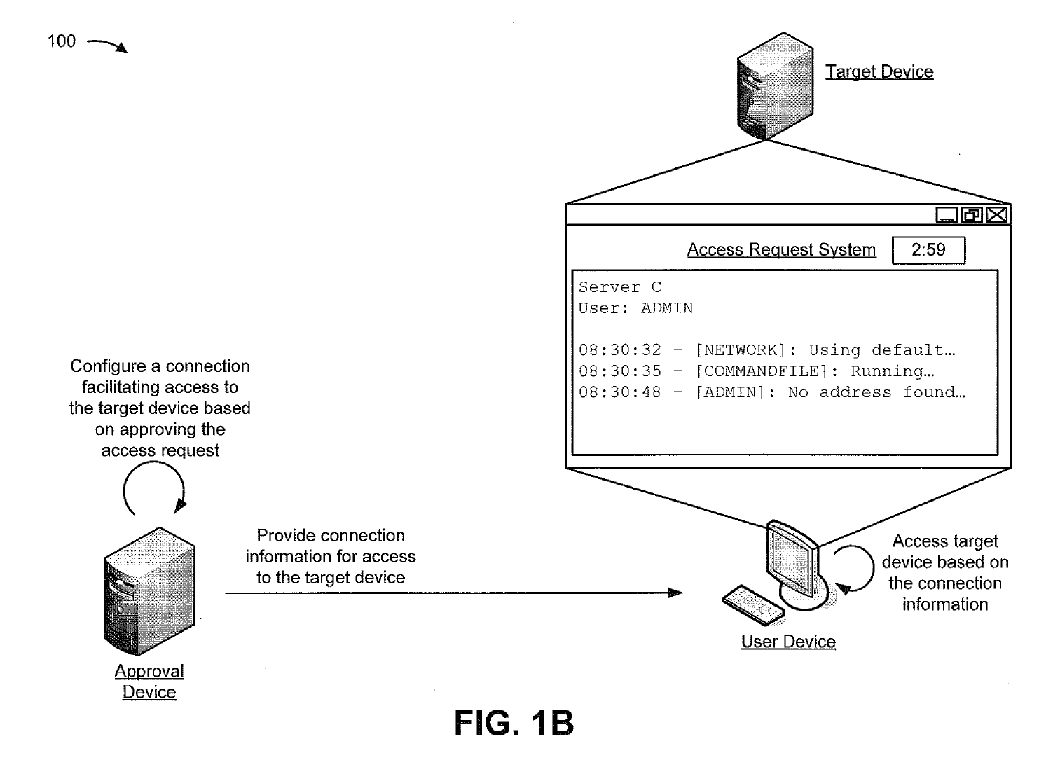

FIGS. 1A and 1B are diagrams of an overview of an example implementation 100 described herein. Example implementation 100 may include a user device and an approval device. As shown in FIG. 1A, a user associated with the user device may provide an access request for access (e.g., administrator-level access) to a target device, such as a server, a storage device, or the like. The user device may provide authorization information associated with the request (e.g., a user account identifier, a user location identifier, a target device identifier, etc.) to the approval device for validation. For example, the approval device may validate the access request based on processing the authorization information and/or credential information (e.g., provided by a credential storage device).

As further shown in FIG. 1A, the approval device may request justification information associated with the access request. Justification information may refer to a reason why the access request should be permitted. For example, the approval device may request an issue tracking system identifier, such as a trouble ticket identifier, a bug identifier, or the like. The user device may determine the justification information (e.g., based on stored justification information, based on querying the user, etc.), and may provide the justification information associated with the access request. For example, the user device may provide a trouble ticket identifier associated with the target device. The approval device may receive the justification information, and may approve the access request based on the justification information. For example, the approval device may utilize a review of the justification information by a supervisory authority (e.g., a supervisory user, a supervisory device, etc.), and may approve the access request based on receiving approval from the supervisory authority.

As shown in FIG. 1B, the approval device may configure a connection for facilitating access to the target device based on approving the access request. For example, the approval device may utilize a credential (e.g., an administrator-level credential) to establish a connection (e.g., a temporary connection) through which the user device may access the target device (e.g., via a browser administrator-level terminal session). The approval device may provide connection information identifying the connection to the user device. For example, the approval device may provide a hyperlink for the user to utilize in accessing the browser administrator-level terminal session with the target device. Based on receiving the connection information, the user device may access the connection, and may provide the browser administrator-level terminal session to the user.

In this way, an approval device may provide a user temporary access to a target device without exposing an administrator-level credential associated with the target device.

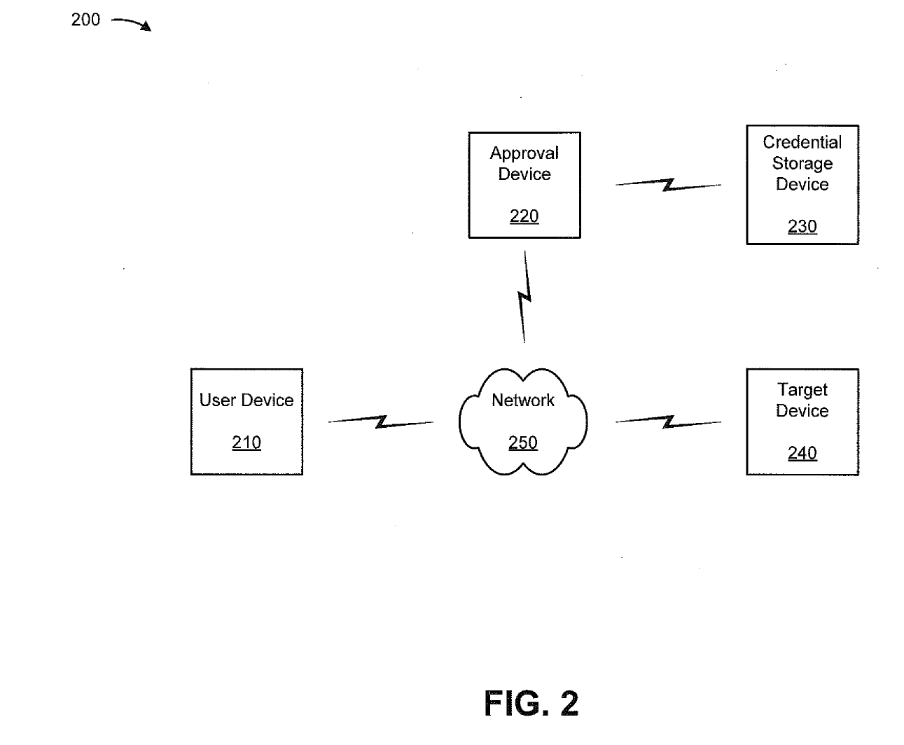

FIG. 2 is a diagram of an example environment 200 in which systems and/or methods described herein may be implemented. As shown in FIG. 2, environment 200 may include user device 210, approval device 220, credential storage device 230, target device 240, and network 250. Devices of environment 200 may interconnect via wired connections, wireless connections, or a combination of wired and wireless connections.

User device 210 may include one or more devices capable of receiving, generating, processing, storing, and/or providing information associated with access to target device 240. For example, user device 210 may include a computer (e.g., a desktop computer, a laptop computer, a tablet computer, etc.), a mobile phone (e.g., a smart phone), a radiotelephone, a personal communications systems (PCS) terminal (e.g., that may combine a cellular radiotelephone with data processing and data communications capabilities), a personal digital assistant (PDA) (e.g., that may include a radiotelephone, a pager, Internet/intranet access, etc.), or a similar type of device. In some implementations, user device 210 may be associated with a particular location (e.g., identified by a network address, a location identifier, or the like). In some implementations, user device 210 may communicate with approval device 220 and/or target device 240 via network 250.

Approval device 220 may include one or more devices capable of receiving, generating, processing, storing, and/or providing information associated with establishing a connection between user device 210 and target device 240. For example, approval device 220 may include a computer (e.g., a desktop computer, a laptop computer, a tablet computer, etc.), a server, or a similar type of device capable of processing a credential, such as a user-level credential, an administrator-level credential, or the like, and establishing the connection using the credential. In some implementations, approval device 220 may be associated with a terminal device (e.g., a computer) for receiving user input (e.g., user input associated with a supervisory authority, such as a supervisory user, an administrator, or the like).

Credential storage device 230 may include one or more devices capable of receiving, generating, processing, storing, and/or providing credential information associated with validating an access request. For example, credential storage device 230 may include a server, a storage device, or another similar device with access to information associated with user device 210, a user associated with user device 210, target device 240, or the like. In some implementations, credential storage device 230 may include a credential store (e.g., a set of data structures, such as a user credential data structure, a server access data structure, or the like) associated with providing information validating that a user is authorized to request a particular level of access, information indicating that a supervisory authority is to be utilized for approving the particular level of access, or the like. In some implementations, credential storage device 230 may communicate with approval device 220 via network 250.

Target device 240 may include one or more devices capable of receiving, generating, processing, storing, and/or providing information via a connection. For example, target device 240 may include a server (e.g., a terminal server, a domain server, etc.), a computer (e.g., a desktop computer, a laptop computer, a tablet computer, etc.), a load balancer, a network device (e.g., a router, a gateway, a base station, etc.), or a similar type of device capable of having the connection (e.g., an administrator-level access connection) established with user device 210. In some implementations, target device 240 may be associated with a set of geographic restrictions (e.g., a set of geographic locations between which the connection may be established). In some implementations, target device 240 may be associated with an issue tracking system identifier, such as a trouble ticket identifier, a bug tracking system identifier, a request management identifier, or the like. For example, when an error is detected regarding a functionality of target device 240, a particular trouble ticket identifier may be issued to indicate that approval device 220 is permitted to provide a user (e.g., associated with user device 210) access to target device 240 to restore the functionality of target device 240.

Network 250 may include one or more wired and/or wireless networks. For example, network 250 may include a cellular network (e.g., a long term evolution (LTE) network, a code division multiple access (CDMA) network, etc.), a public land mobile network (PLMN), a Wi-Fi network, a local area network (LAN), a wide area network (WAN), a metropolitan area network (MAN), a telephone network (e.g., the Public Switched Telephone Network (PSTN)), an ad hoc network, an intranet, the Internet, a fiber optic-based network, and/or a combination of these or other types of networks.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. For example, while approval device 220 and credential storage device 230 are shown as separate devices, approval device 220 and credential storage device 230 may be implemented in a single device or in a single collection of devices. Additionally, one or more of the devices of environment 200 may perform one or more functions described as being performed by another one or more devices of environment 200.

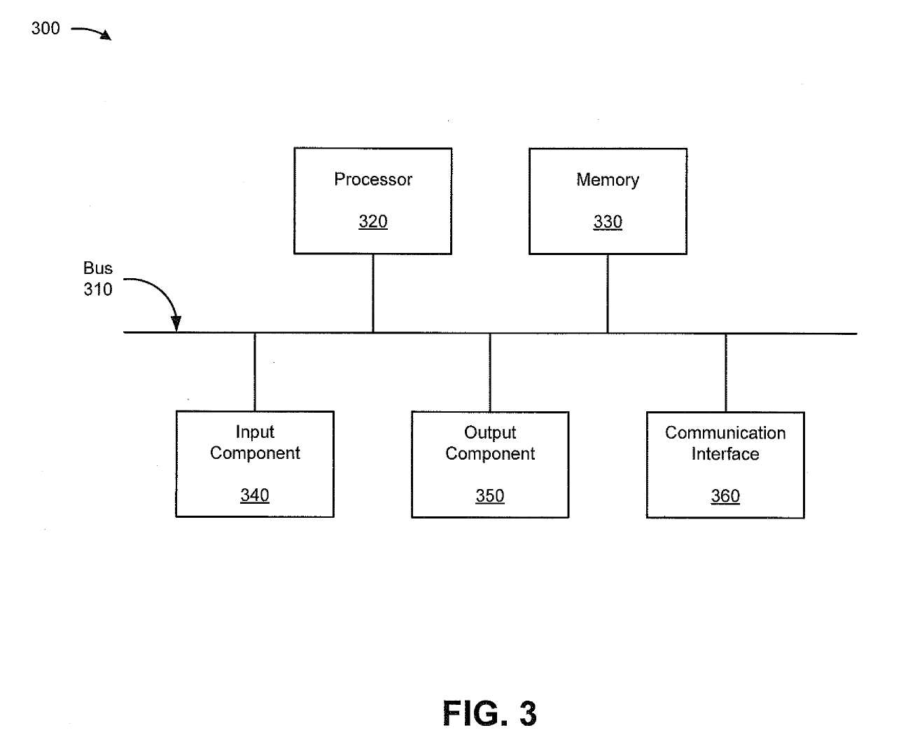

FIG. 3 is a diagram of example components of a device 300. Device 300 may correspond to user device 210, approval device 220, credential storage device 230, and/or target device 240. In some implementations, each of user device 210, approval device 220, credential storage device 230, and/or target device 240 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions included in a computer-readable medium, such as memory 330. A computer-readable medium is defined herein as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3.

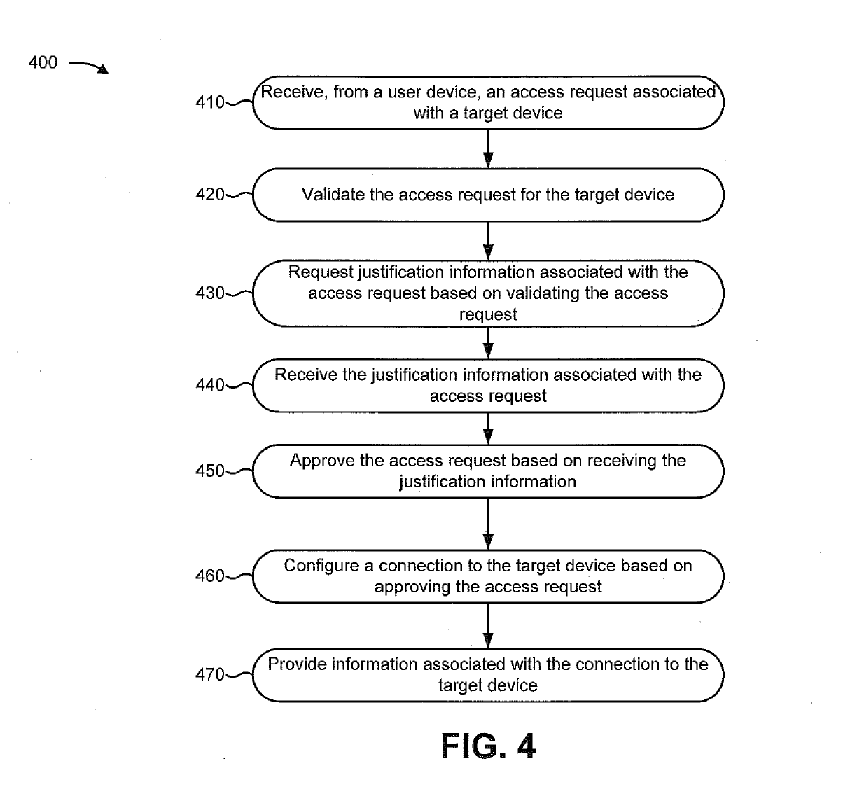

FIG. 4 is a flow chart of an example process for providing, to a user, access to a target device. In some implementations, one or more process blocks of FIG. 4 may be performed by approval device 220. Additionally, or alternatively, one or more process blocks of FIG. 4 may be performed by another device or a group of devices separate from or including approval device 220, such as user device 210, credential storage device 230, and/or target device 240.

As shown in FIG. 4, process 400 may include receiving, from a user device, an access request associated with a target device (block 410). For example, approval device 220 may receive, from user device 210, the access request to provide administrator-level access to target device 240. An access request may refer to a request for a connection to a particular target device 240. For example, user device 210 may provide an access request seeking an administrator-level access to target device 240 via a secure shell connection.

Access may be associated with a particular hierarchy of levels of access (e.g., a user-level access may include a particular set of actions that may be performed, a manager-level access may include the particular set of actions of the user-level access and another set of actions that may be performed, an administrator-level access may include the particular set of actions of the manager-level access and yet another set of actions that may be performed, etc.). For example, the user may utilize a user-level access to view a set of data structures associated with target device 240. Additionally, or alternatively, the user may utilize a manager-level access to view the set of data structures and/or add a new data structure to the set of data structures. Additionally, or alternatively, the user may utilize an administrator-level access to view the set of data structures, add a new data structure to the set of data structures, and/or modify file contents of the set of data structures. Although the levels of access are described in terms of a user-level, a manager-level, and/or an administrator-level, other levels of access different from, or including the user-level, the manager-level, and/or the administrator-level may be utilized.

In some implementations, approval device 220 may receive the access request via a particular interface. For example, a user associated with user device 210 may utilize the particular interface (e.g., a system application interface, a web browser interface, a web application interface, etc.) to transmit the access request to approval device 220. In some implementations, approval device 220 may provide information associated with configuring the particular interface for user device 210. For example, approval device 220 may provide information indicating information that is to be provided when transmitting the access request, such as identity information, location information, or the like.

In some implementations, approval device 220 may receive identification information from user device 210 when receiving the access request. For example, user device 210 may provide information identifying the user (e.g., a user name identifier, a user account identifier, etc.), a user credential (e.g., a user qualification for requesting access, such as an operational role identifier, a user password, a user security clearance identifier, etc.), a user location (e.g., a country identifier, a city identifier, a facility identifier, a network identifier, a device identifier associated with user device 210, etc.), or the like.

In some implementations, approval device 220 may receive the access request based on generation of a trouble ticket. A trouble ticket may refer to an issue tracking system indication of an error associated with target device 240. For example, a particular user utilizing target device 240 may detect the error associated with target device 240, and may request a trouble ticket be generated to identify maintenance associated with rectifying the error. In this case, the trouble ticket may be provided to another particular user (e.g., a maintenance engineer, an escalation engineer, or the like) associated with user device 210, and approval device 220 may receive the access request to provide the particular user with administrator-level access for rectifying the error.

As further shown in FIG. 4, process 400 may include validating the access request for the target device (block 420). For example, approval device 220 may validate the access request for administrator-level access to target device 240 by user device 210. In some implementations, approval device 220 may query credential storage device 230 when validating the access request. For example, approval device 220 may provide authorization information to credential storage device 230, and may receive information associated with validating the access request, such as information (e.g., credential information) associated with a set of locations for which the access request is valid, a set of user levels (e.g., operational roles) for which the access request is valid, or the like. Authorization information may refer to information associated with the access request. For example, approval device 220 may provide authorization information identifying target device 240 to credential device 230, and may receive credential information identifying the set of locations for which the access request is valid.

In some implementations, approval device 220 may validate the access request based on determining that user device 210 is associated with a particular user level. For example, when approval device 220 determines that a threshold user level (e.g., associated with a hierarchical set of operational roles) is required for access (e.g., administrator-level access), approval device 220 may validate the access request based on determining that the user level associated with user device 210 satisfies the threshold.

Additionally, or alternatively, approval device 220 may validate the access request based on determining that user device 210 is associated with a particular location for access. For example, when approval device 220 determines that target device 240 may provide access to users associated with one or more geographic locations, approval device 220 may validate the access request based on determining that the location associated with user device 210 is one of the one or more geographic locations.

As further shown in FIG. 4, process 400 may include requesting justification information associated with the access request based on validating the access request (block 430). For example, approval device 220 may request that user device 210 provide justification information associated with the access request. Justification information may refer to a reason why the particular access request should be permitted. For example, approval device 220 may request justification information that includes a trouble ticket identifier, a request management identifier (e.g., associated with indicating that the user is scheduled to perform maintenance on target device 240), a bug tracking identifier, or the like.

As further shown in FIG. 4, process 400 may include receiving the justification information associated with the access request (block 440). For example, approval device 220 may receive the justification information from user device 210 (e.g., via network 250). In some implementations, approval device 220 may receive the justification information via a particular interface (e.g., a web interface, an application interface, or the like). Additionally, or alternatively, approval device 220 may receive the justification information via a message, such as an email message, an online chat message, a LAN message, a text message, or the like. For example, approval device 220 may receive an email including the justification information, and may process the email to extract the justification information, such as a trouble ticket identifier, a request management identifier, or the like, included in the email.

As further shown in FIG. 4, process 400 may include approving the access request based on receiving the justification information (block 450). For example, approval device 220 may approve the access request based on receiving the justification information from user device 210. In some implementations, approval device 220 may approve the access request based on querying a data structure storing justification information. For example, approval device 220 may query a particular data structure (e.g., associated with credential storage device 230) to determine that a trouble ticket identifier provided by user device 210, as justification information, is approved for a particular level of access to target device 240.

Approval device 220 may approve the access request based on receiving approval for the access request from a supervisory authority, in some implementations. A supervisory authority may refer to a supervising user authorized to approve a particular access request. For example, approval device 220 may provide information associated with the access request, such as information identifying user device 210, information identifying a user associated with user device 210, information identifying a location associated with user device 210, justification information provided by user device 210, or the like, to the supervisory authority (e.g., via a terminal console, via an email message, etc.). In this case, approval device 220 may approve the request based on receiving a response from the supervisory authority. In some implementations, the response from the supervisory authority may include connection limitation information, such as time limitation information (e.g., information associated with a quantity of time for which the connection is to be established), access limitation information (e.g., information associated with determining a subset of systems associated with target device 240 for which access is to be approved, such as a subset of data structures, a subset of storage devices, a subset of processors, etc.), or the like. Additionally, or alternatively, the response from the supervisory authority may include a particular credential (e.g., an administrator-level credential) for configuring a connection facilitating access to target device 240.

As further shown in FIG. 4, process 400 may include configuring a connection to the target device based on approving the access request (block 460). For example, approval device 220 may configure the connection to target device 240 based on approving the access request. In some implementations, approval device 220 may establish a particular type of connection, such as a secure shell (SSH) connection for remote access, an encrypted tunnel (e.g., an internet protocol security (IPsec) tunnel), a terminal session, or the like. In some implementations, approval device 220 may decrypt a credential associated with the requested level of access (e.g., an encrypted administrator-level credential associated with providing administrator-level access), and may configure the connection utilizing the decrypted credential (e.g., without exposing the decrypted credential to the user associated with user device 210).

Approval device 220 may configure a connection termination when configuring the connection, in some implementations. For example, approval device 220 may establish one or more parameters associated with terminating the connection, such as a time parameter (e.g., a threshold quantity of time after which the connection is to be severed), a disconnect parameter (e.g., a threshold quantity of disconnects after which the connection is to be severed), or the like. In some implementations, approval device 220 may determine the one or more parameters associated with terminating the connection based on receiving information from the supervisory authority. For example, the supervisory authority may provide information to approval device 220 indicating that the connection is to be provided for a particular quantity of time.

As further shown in FIG. 4, process 400 may include providing information associated with the connection to the target device (block 470). For example, approval device 220 may provide, to user device 210, information associated with the connection to target device 240. In some implementations, approval device 220 may provide the information associated with the connection via a message (e.g., a web application message, an email message, a text message, etc.) that includes an address identifier for the connection (e.g., a network address identifier, such as an internet protocol address, a port address, a web link, a hyperlink, or the like). For example, when approval device 220 generates a web link that provides encrypted information to target device 240 associated with administrator-level access to target device 240, approval device 220 may provide the web link via an email to user device 210. In this case, when a user associated with user device 210 accesses the web link, approval device 220 may transparently log the user into target device 240 using a set of administrator-level credentials (e.g., provided by a supervisory authority). Moreover, if the user of user device 210 needs additional time for access to target device 240, user device 210 may provide a request for additional time, repeat the above-described operations, or the like.

Approval device 220 may provide forensic information when providing information associated with the connection, in some implementations. For example, approval device 220 may generate forensic information, such as authorization information (e.g., user identification information, user location information, etc.), justification information (e.g., trouble ticket identification information, etc.), supervisory authority information (e.g., supervisory user identification information, etc.), connection information (e.g., connection type information, connection duration information, etc.), or the like, and may provide the forensic information for quality control, for storage, or the like.

In this way, an approval device may provide, to a user device, administrator-level access to a target device without exposing an administrator-level credential to the user device.

Although FIG. 4 shows example blocks of process 400, in some implementations, process 400 may include additional blocks, different blocks, fewer blocks, or differently arranged blocks than those depicted in FIG. 4. Additionally, or alternatively, two or more of the blocks of process 400 may be performed in parallel.

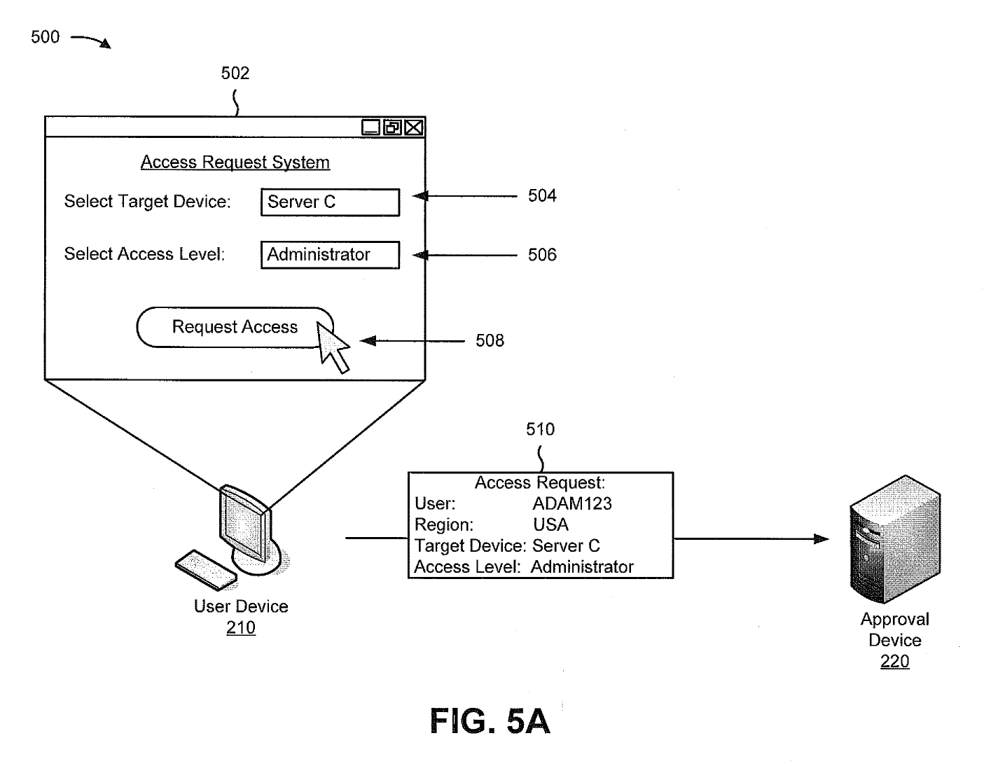

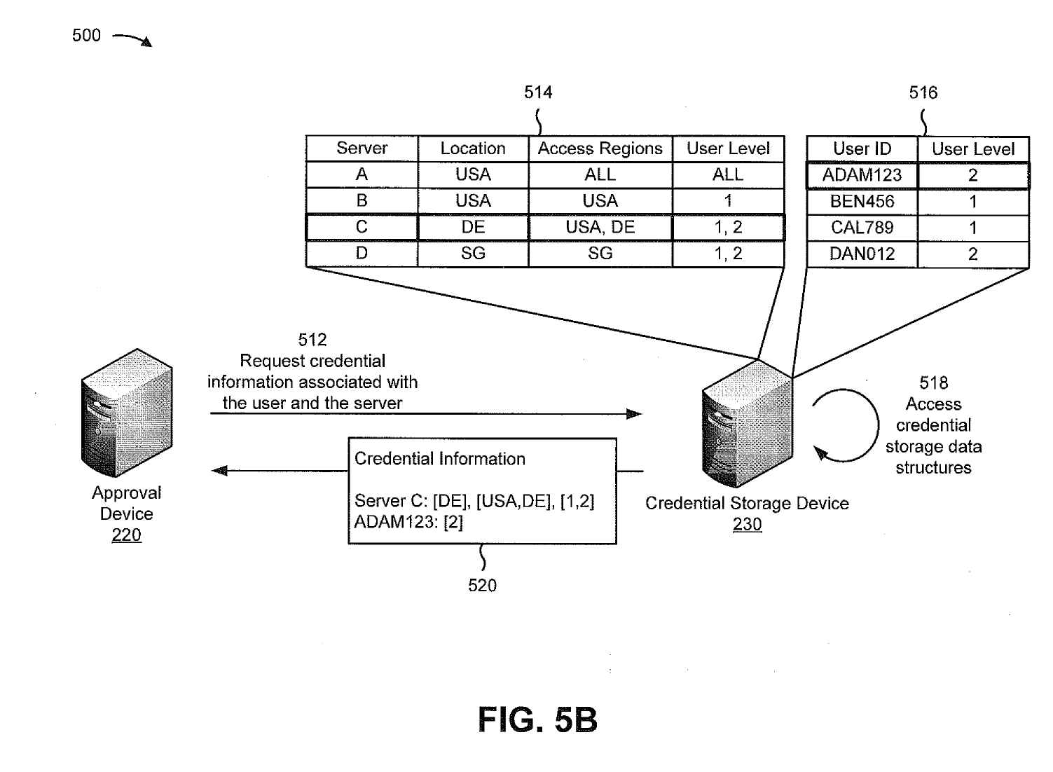

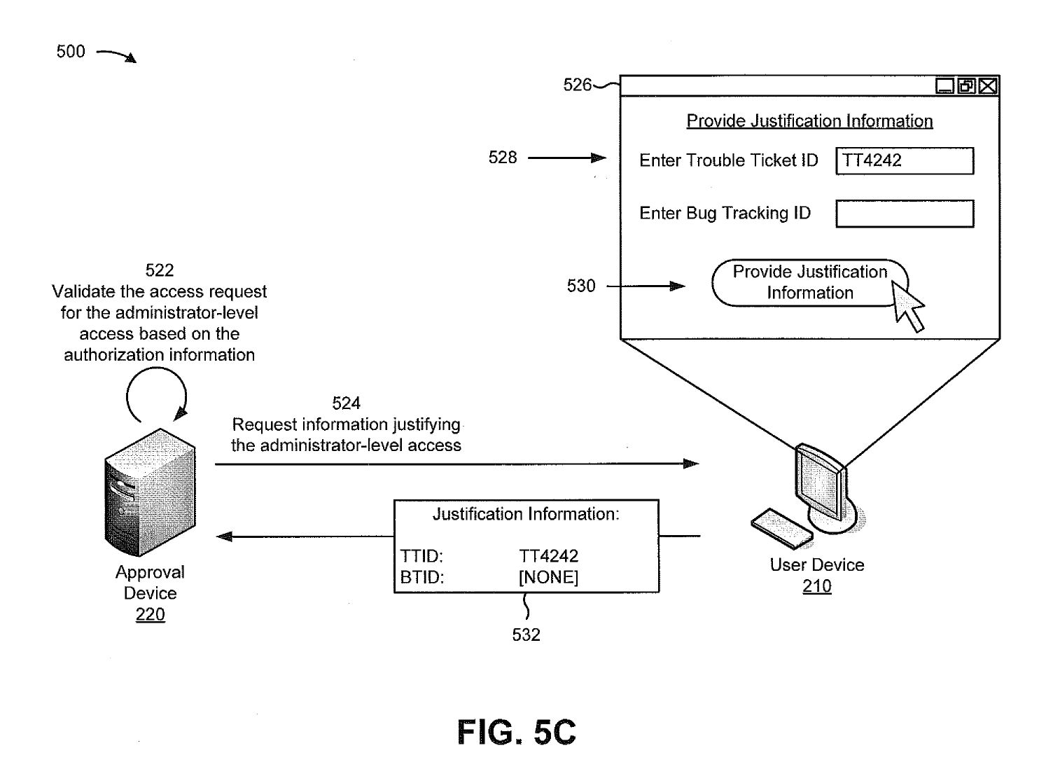

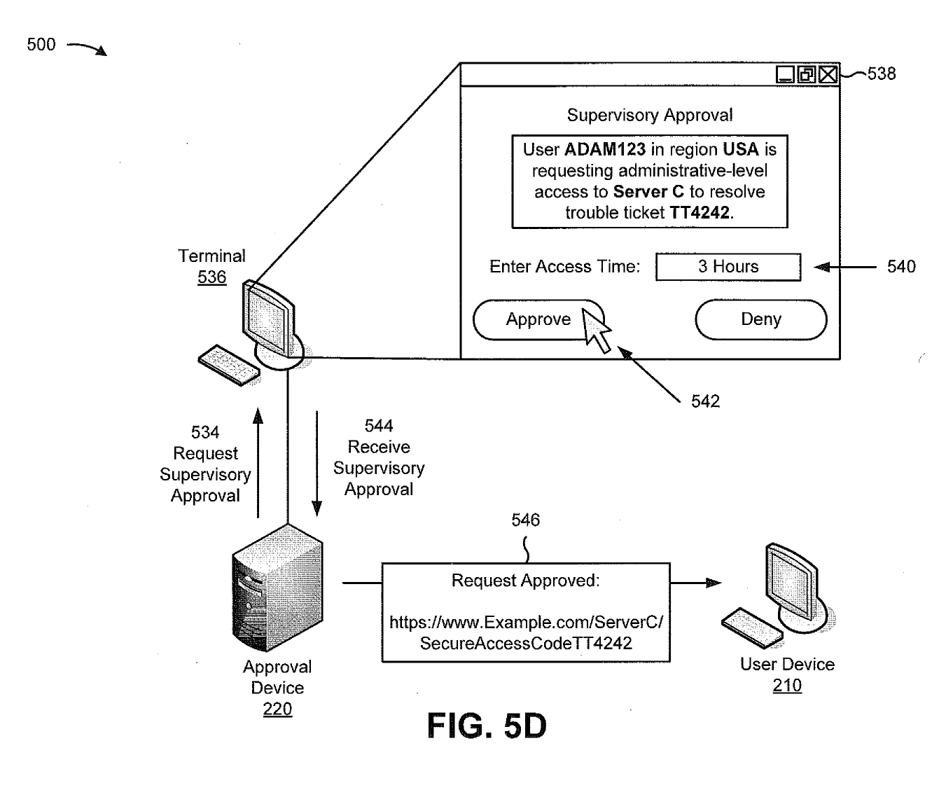

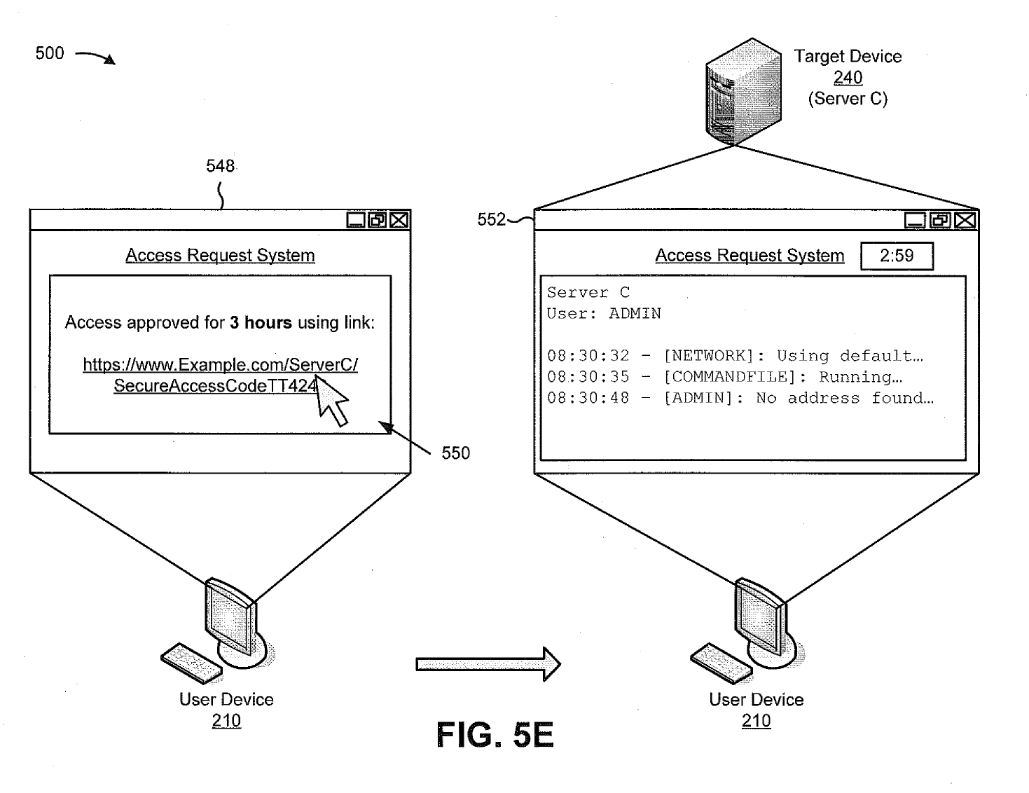

FIGS. 5A-5E are diagrams of an example implementation 500 relating to process 400 shown in FIG. 4. As shown in FIG. 5A, example implementation 500 includes user device 210 and approval device 220. As shown by reference number 502, user device 210 provides an application interface (e.g. “Access Request System”) for requesting a particular level of access to a set of target devices 240. As shown by reference number 504, a user associated with user device 210 provides an indication that access is to be requested for a particular target device 240 (e.g., “Server C”), and as shown by reference number 506, the user provides an indication that administrator-level access (e.g., “Administrator”) is to be requested. As shown by reference number 508, based on user interaction with a button, user device 210 provides an access request to approval device 220. As shown by reference number 510, the access request includes information identifying the user (e.g., “ADAM123”), a location associated with the user (e.g. “USA”), target device 240, and the administrator-level access.

As shown in FIG. 5B, and by reference number 512, approval device 220 requests credential information associated with user ADAM123 and target device 240 from credential storage device 230 (e.g., information associated with validating the access request by determining that user ADAM123 is associated with a sufficient user level to request administrator-level access to target device 240). As shown by reference number 514, credential storage device 230 includes a first credential storage data structure storing information associated with the set of target devices 240, such as information indicating that target device 240 (e.g., Server C) is associated with a particular location (e.g., “DE”), that target device 240 may be accessed by users associated with a set of locations (e.g., “USA, DE”), and that administrator-level access may be granted to users associated with a set of user levels (e.g., “1, 2”). As shown by reference number 516, credential storage device 230 includes a second credential storage data structure storing information associated with a set of users, such as information indicating that user ADAM123 is associated with a particular user level (e.g., “2”). As shown by reference number 518, credential storage device 230 accesses the set of credential storage data structures and, as shown by reference number 520, provides the credential information associated with target device 240 and user ADAM123 to approval device 220.

As shown in FIG. 5C, and by reference number 522, approval device 220 validates the access request based on determining that user ADAM123 is authorized to request the administrator-level access (e.g., user ADAM123 is associated with the set of locations and the user level for which the access request may be approved). As shown by reference number 524, based on validating the access request, approval device 220 requests, from user device 210, justification information associated with approving the administrator-level access. As shown by reference number 526, user device 210 provides the application interface for user ADAM123 to provide justification information associated with the administrator level-access (e.g., “Provide Justification Information”). As shown by reference number 528, user ADAM123 provides a trouble ticket identifier (e.g., “TT4242”). As shown by reference number 530, based on user interaction with a button, user device 210 provides the justification information to approval device 220. As shown by reference number 532, the justification information includes the trouble ticket identifier, and includes information indicating that a bug tracking identifier is not provided (e.g., “BTID: [NONE]”).

As shown in FIG. 5D, and by reference number 534, based on receiving the justification information, approval device 220 requests that a supervisory authority (e.g., a supervisory user) approve the access request for administrator-level access. Approval device 220 provides information associated with the access request (e.g., the information identifying the user, the justification information, etc.) to terminal 536 (e.g., a terminal device associated with the supervisory user). As shown by reference number 538, terminal 536 provides another application interface identifying the access request for administrator-level access for evaluation by the supervisory user. As shown by reference number 540, the supervisory user provides an indication of a quantity of time for which the administrator-level access is to be granted (e.g., “3 Hours”). As shown by reference number 542, based on user interaction with a button, the supervisory user approves the access request for administrator-level access. As shown by reference number 544, terminal 536 provides approval of the access request for administrator-level access to approval device 220. Assume that based on receiving the approval from the supervisory authority, approval device 220 approves the access request, and approval device 220 generates a connection facilitating the administrator-level access to target device 240. As shown by reference number 546, approval device 220 provides connection information (e.g., a web link associated with the connection facilitating the administrator-level access to Server C) to user device 210.

As shown in FIG. 5E, and by reference number 548, user device 210 displays the connection information via the application interface. As shown by reference number 550, based on user selection of the web link associated with the connection facilitating the administrator-level access to Server C, user device 210 provides information to target device 240 associated with utilizing the administrator-level access to Server C. Assume that based on the user selection of the web link, approval device 220 transparently logs user ADAM123 into Server C using one or more administrator-level credentials. As shown by reference number 552, user device 210 provides the administrator-level access via the application interface, and user device 210 displays information regarding the quantity of time before the connection is terminated (e.g., “2:59”) for review. If the user of user device 210 needs additional time to service Server C, user device 210 may request the additional time or repeat the above-described operations.

As indicated above, FIGS. 5A-5E are provided merely as an example. Other examples are possible and may differ from what was described with regard to FIGS. 5A-5E.

Implementations described herein may assist an approval device in granting a particular level of access to a user without revealing, to the user, a credential associated with the particular level of access.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

To the extent the aforementioned implementations collect, store, or employ personal information provided by individuals, it should be understood that such information shall be used in accordance with all applicable laws concerning protection of personal information. Storage and use of personal information may be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A device, comprising:
a memory; and
one or more processors to:
receive, from a user device, an access request associated with a target device,
the access request including information identifying a particular level of access;
validate the access request;
request, from the user device, justification information associated with the access request based on validating the access request,
the justification information being a reason why the particular level of access should be permitted;
receive, from the user device, the justification information associated with the access request based on requesting the justification information;
approve the access request based on the justification information;
configure a connection to the target device based on approving the access request; and
provide, to the user device and without revealing credential information associated with the particular level of access, information associated with the connection to the target device based on configuring the connection to the target device.

2. The device of claim 1,
where the one or more processors, when receiving the access request, are to:
receive information identifying a user associated with the access request; and
query a credential data structure to receive information associated with the user; and
where the one or more processors, when validating the access request, are to:
validate the access request based on querying the credential data structure to receive the information associated with the user.

3. The device of claim 1,
where the one or more processors, when receiving the access request, are to:
determine a particular geographic location associated with the access request; and
identify a set of geographic locations associated with authorized access to the target device,
the set of geographic locations including the particular geographic location associated with the access request; and
where the one or more processors, when validating the access request, are to:
validate the access request based on a matching of the particular geographic location and the set of geographic locations associated with authorized access to the target device.

4. The device of claim 1,
where the one or more processors are further to:
provide the justification information to a supervisory authority; and
receive approval of the access request from the supervisory authority based on providing the justification information; and
where the one or more processors, when approving the access request, are to:
approve the access request based on receiving the approval of the access request from the supervisory authority.

5. The device of claim 1,
where the one or more processors, when configuring the connection to the target device, are to:
configure a secure shell connection to the target device using the credential information associated with the particular level of access; and
where the one or more processors, when providing the information associated with the connection, are to:
provide information identifying the secure shell connection to the user device,
the information identifying the secure shell connection not including the credential information.

6. The device of claim 1,
where the one or more processors are further to:
receive the credential information from a supervisory authority; and
where the one or more processors, when configuring the connection to the target device, are to:
configure the connection to the target device based on receiving the credential information from the supervisory authority.

7. The device of claim 1,
where the justification information includes a trouble ticket identifier; and
where the one or more processors, when approving the access request, are to:
approve the access request based on the trouble ticket identifier.

8. A non-transitory computer-readable medium storing instructions, the instructions comprising:
one or more instructions that, when executed by one or more processors, cause the one or more processors to:
receive an access request for a particular level of access to a target device,
the access request including information identifying a user associated with the access request;
query a credential data structure to determine authorization for the access request;
request, from a user device associated with the user, justification information associated with the access request based on querying the credential data structure to determine authorization for the access request,
the justification information being a reason why the particular level of access should be provided;
receive, from the user device associated with the user, the justification information associated with the access request;
approve the access request based on the justification information;
establish a connection for the user device to access the target device based on approving the access request;
provide, to the user device, information associated with the connection based on establishing the connection,
the information associated with the connection not including information associated with identifying a credential associated with the particular level of access.

9. The non-transitory computer-readable medium of claim 8,
where the instructions further comprise:
one or more instructions that, when executed by the one or more processors, cause the one or more processors to:
establish a trouble ticket associated with the target device; and
assign the user device, associated with the user, to perform maintenance of the target device based on establishing the trouble ticket; and
where the one or more instructions to receive the access request comprise:
one or more instructions that, when executed by the one or more processors, cause the one or more processors to:
receive the access request from the user device based on assigning the user device, associated with the user, to perform maintenance of the target device.

10. The non-transitory computer-readable medium of claim 8,
where the instructions further comprise:
one or more instructions that, when executed by the one or more processors, cause the one or more processors to:
identify a particular geographic region associated with the user device; and
where the one or more instructions to query the credential data structure to determine authorization for the access request comprise:
one or more instructions that, when executed by the one or more processors, cause the one or more processors to:
query the credential data structure to determine a set of geographic regions for which access to the target device may be granted,
the set of geographic regions including the particular geographic region associated with the user device; and
determine that the user of the user device is authorized for the access request based on a matching of the particular geographic region and the set of regions for which access to the target device may be granted.

11. The non-transitory computer-readable medium of claim 8,
where the instructions further comprise:
one or more instructions that, when executed by the one or more processors, cause the one or more processors to:
provide the justification information to a terminal associated with a supervising user; and
receive an approval of the access request from the terminal associated with the supervising user; and
where the one or more instructions to approve the access request comprise:
one or more instructions that, when executed by the one or more processors, cause the one or more processors to:
approve the access request based on receiving the approval of the access request from the terminal associated with the supervising user.

12. The non-transitory computer-readable medium of claim 8,
where the target device is a particular target device;
where one or more instructions to receive the justification information comprise:
one or more instructions that, when executed by the one or more processors, cause the one or more processors to:
receive issue tracking system information associated with the user; and
query a data structure storing information regarding a set of target devices,
the set of target devices including the particular target device, and
the data structure including information indicating that the issue tracking system information is associated with the particular target device; and
where the one or more instructions to approve the access request comprise:
one or more instructions that, when executed by the one or more processors, cause the one or more processors to:
approve the access request based on querying the data structure storing information regarding the set of target devices.

13. The non-transitory computer-readable medium of claim 8,
where the instructions further comprise:
one or more instructions that, when executed by the one or more processors, cause the one or more processors to:
identify the credential associated with the particular level of access; and
where the one or more instructions to establish the connection comprise:
one or more instructions that, when executed by the one or more processors, cause the one or more processors to:
establish a terminal connection based on identifying the credential associated with the particular level of access.

14. The non-transitory computer-readable medium of claim 8,
where the one or more instructions to establish the connection comprise:
one or more instructions that, when executed by the one or more processors, cause the one or more processors to:
generate a hyperlink associated with facilitating access to the target device, the hyperlink being associated with encrypted connection information; and
where the information associated with the connection includes information identifying the hyperlink.

15. A method, comprising:
receiving, by a device and from a user device, an access request associated with a target device,
the device including hardware, and
the access request requesting a particular level of access to the target device;
determining, by the device, that the access request is associated with an authorized user and/or an authorized geographic location;
requesting, by the device and from the user device, justification information associated with approving the access request based on determining that the access request is associated with the authorized user and/or the authorized geographic location,
the justification information being a reason why the particular level of access to the target device should be provided;
receiving, by the device and from the user device, the justification information associated with approving the access request;
approving, by the device, the access request based on the justification information;
determining, by the device, an access credential for configuring a connection to the target device based on approving the access request;
configuring, by the device, the connection to the target device utilizing the access credential; and
providing, by the device, information associated with the connection to the target device based on configuring the connection,
the information associated with the connection to the target device not revealing information identifying the access credential.

16. The method of claim 15, further comprising:
generating forensic information associated with the connection,
the forensic information including information identifying the authorized user and/or the authorized geographic location; and
where the information associated with the connection comprises the forensic information.

17. The method of claim 15, further comprising:
receiving information identifying a particular user and/or a particular geographic location,
where determining that the access request is associated with the authorized user and/or the authorized geographic location comprises:
querying a credential data structure to determine that the particular user and/or the particular geographic location are included in a set of authorized users and/or a set of authorized geographic locations.

18. The method of claim 15,
where the connection to the target device comprises an internet protocol security connection to the target device; and
where the information associated with the connection comprises information identifying the internet protocol security connection.

19. The method of claim 15, further comprising:
providing the justification information for review by a supervisory authority; and
receiving an approval of the access request from the supervisory authority,
where approving the access request comprises:
approving the access request based on receiving approval of the access request from the supervisory authority.

20. The method of claim 15, further comprising:
determining a quantity of accesses associated with terminating the connection to the target device,
where configuring the connection to the target device comprises:
configuring the connection to the target device based on the quantity of accesses associated with terminating the connection to the target device.
